(19) United States
(12) Patent Application Publication
(10) Pub. No.: US 2024/0009953 A1
(43) Pub. Date: Jan. 11, 2024

(54) Apparatus and method for manufacturing of spirally wound tubes

(71) Applicant: International Tobacco Machinery Poland Sp. z o. o., Radom (PL)

(72) Inventor: Krzysztof Sotowski, Radom (PL)

(21) Appl. No.: 18/245,896

(22) PCT Filed: Sep. 7, 2021
(86) PCT No.: PCT/EP2021/074575

§ 371 Date: Mar. 19, 2023

(30) Foreign Application Priority Data
Oct. 12, 2020 (EP) 20201334

(51) Int. Cl. B31C 3/00; B26D 3/16; B26D 7/18; B26D 1/00

(52) U.S. Cl. CPC B31C 3/00; B26D 3/16; B26D 7/1863; B26D 1/0006; B26D 2001/0073

(57) ABSTRACT

The object of the application is an apparatus (1) for manufacturing of spiral tubes (2) having at least two layers, comprising at least two feeding units (4, 4′) for feeding a material strand (10, 10), at least one glue unit (5) for feeding the glue onto the material strand (10, 10), a forming unit (6) comprising a forming rod (13) and a forming strip (14) winding around a formed fragment of a continuous spiral tube (3), and a cutting head (7) for cutting off an individual tube (2) from the continuous spiral tube (3). The apparatus is characterised in that between the forming rod (13) and the cutting head (7) there is situated a cutting unit (8) for cutting the formed or partially formed continuous spiral tube (3) or a scrap section (3A) of the tube. The object of the application is also a method for manufacturing of spiral tubes (2) having at least two layers, in the apparatus (1).

The object of this invention is an apparatus for manufacturing of spiral tubes and a method for manufacturing of spiral tubes.

In many branches of the food industry, there are used spiral tubes manufactured by winding material strands which after winding constitute tube layers. The spiral tubes may have multiple layers, but at least two layers of material are needed to produce a tube having a stable shape. Spiral tube forming apparatuses are known, among others, from documents DE1786551A1, EP1631425B1, US3150575A, US4378966A, US3942418A, W02020099360A1, W02020099361A1. Apparatuses for forming spiral tubes both vertically and horizontally are known, whereas individual tubes are cut off by means of moving circular knives, usually arranged to slide in the direction of movement of the tube being formed.

The problem to be solved by this invention is to provide an apparatus and a method for manufacturing of spiral tubes, allowing to remove fragments of a continuous tube, without the need for manual handling by the operator or with minimal manual handling.

The object of the invention is an apparatus for manufacturing of spiral tubes having at least two layers, comprising at least two feeding units for feeding a material strand, at least one glue unit for feeding glue onto the material strand, a forming unit comprising a forming rod and a forming strip winding around a formed fragment of a continuous spiral tube, and a cutting head for cutting off an individual tube of the continuous spiral tube. The apparatus according to the invention is characterised in that between the forming rod and the cutting head there is situated a cutting unit for cutting the formed or partially formed continuous spiral tube or a scrap section of the tube.

Preferably, the apparatus is characterised by being provided with a conveyor unit for removing a cut-off section of the continuous spiral tube.

Preferably, the apparatus is characterised in that the conveyor unit comprises at least two conveyor rollers.

Preferably, the apparatus is characterised in that the conveyor unit comprises at least one conveyor roller having a concave circumferential surface.

Preferably, the apparatus is characterised in that the conveyor unit comprises at least one conveyor roller having a convex circumferential surface.

Preferably, the apparatus is characterised in that one of the conveyor rollers is driven by a roller drive unit.

Preferably, the apparatus is characterised in that at least one conveyor roller is adjustable.

Preferably, the apparatus is characterised in that the cutting unit comprises at least one circular knife mounted eccentrically or having a spiral cutting edge.

Preferably, the apparatus is characterised in that in the area of the cutting unit a suction nozzle is situated.

The object of the invention is also a method for manufacturing of spiral tubes having at least two layers, in an apparatus in which a material strand is fed through at least two feeding units, glue is fed onto the material strand by means of at least one glue unit, a continuous spiral tube is formed by means of a forming unit comprising a forming rod and a forming strip winding around a formed fragment of the continuous spiral tube, and individual tubes are cut off from the continuous spiral tube formed on the forming rod by means of a cutting head. The method according to the invention is characterised in that the apparatus for manufacturing of the tubes is stopped and in that the at least partially formed spiral tube or a scrap section of the continuous tube between the forming rod and the cutting head is cut by means of a cutting unit.

Preferably, the method is characterised by comprising an additional step wherein the cut-off scrap section of the continuous tube is removed by means of a conveyor unit in the direction opposite to the continuous spiral tube manufacturing direction.

Preferably, the method is characterised in that a fragment is cut off from the scrap section and the cut-off fragment is removed.

Preferably, the method is characterised in that the cut-off fragment is sucked off.

Preferably, the method is characterised in that simultaneously with the cutting through the continuous spiral tube a fragment of the continuous tube is cut out.

Due to the application of the invention, scrap fragments of a continuous tube may be removed without any manual handling by the operator, and no defective tubes or reduced quality tubes are delivered to the unit receiving finished individual tubes.

The object of the invention is described in a preferred embodiment shown in a drawing in which

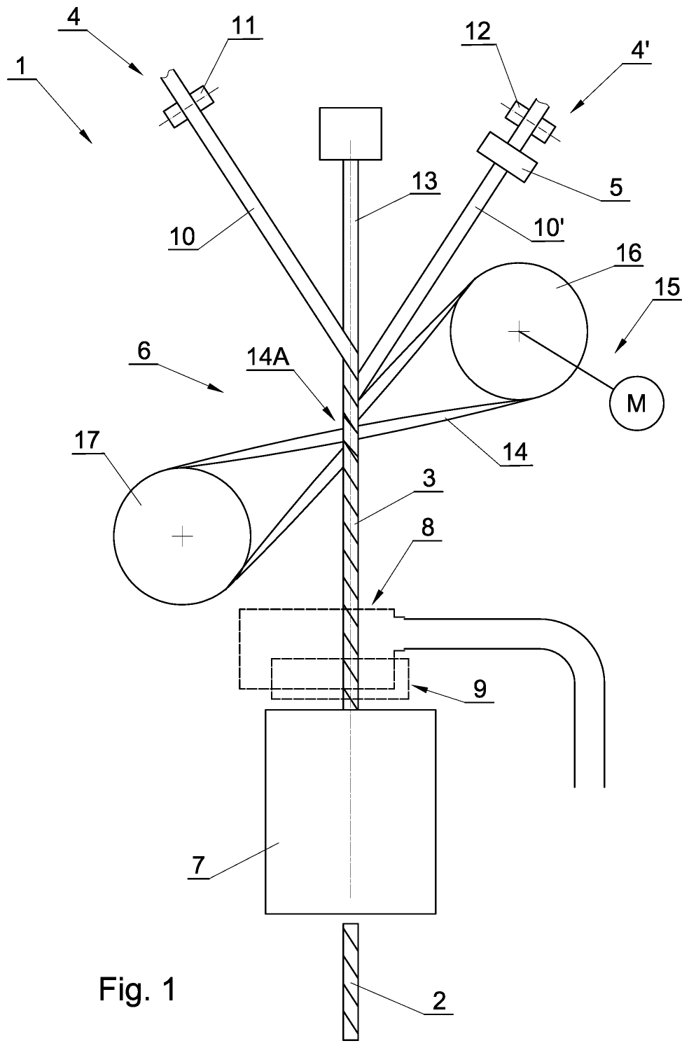

FIG. 1 shows an apparatus for manufacturing of spiral tubes,

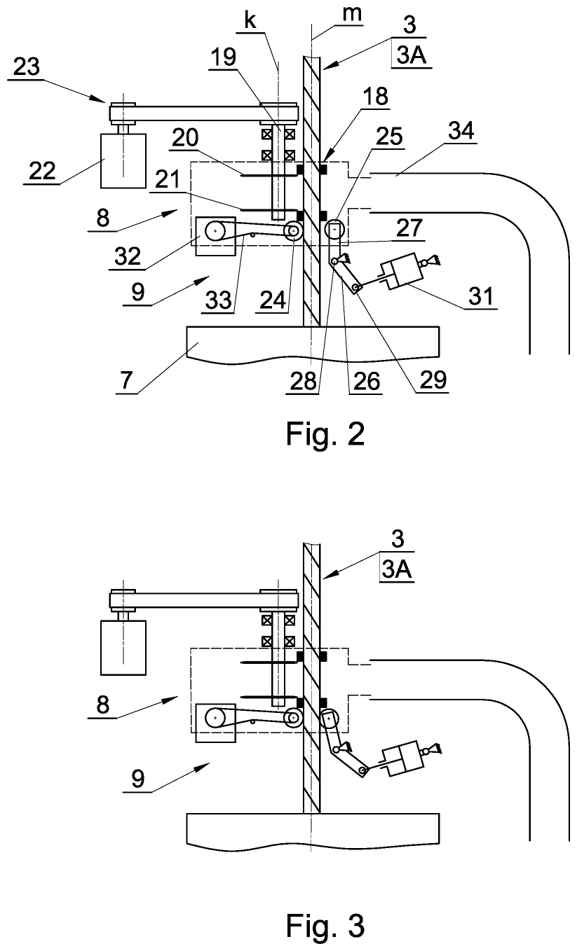

FIG. 2 shows a cutting unit in the first embodiment and a conveyor unit during a spiral tube manufacturing process,

FIG. 3 shows the conveyor unit before cutting a scrap section,

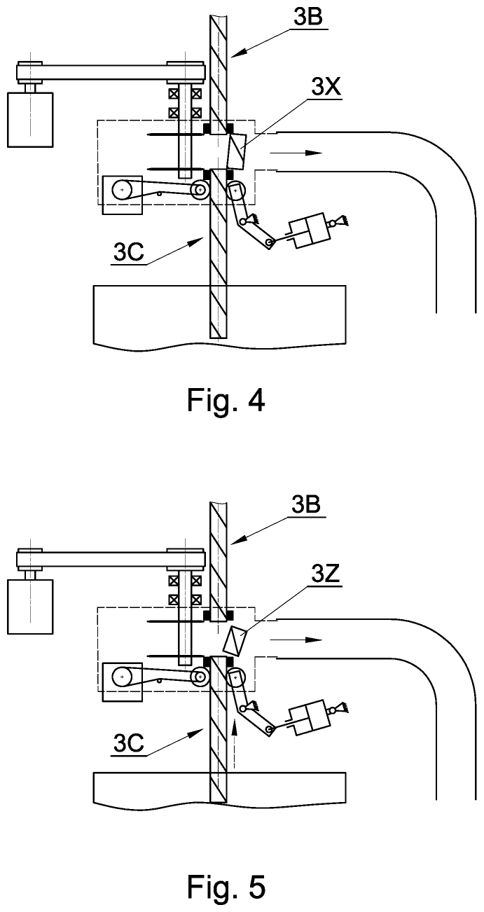

FIG. 4 shows the cutting unit and the conveyor unit after cutting a continuous tube,

FIG. 5 shows the cutting unit and the conveyor unit during removal of a lower scrap section,

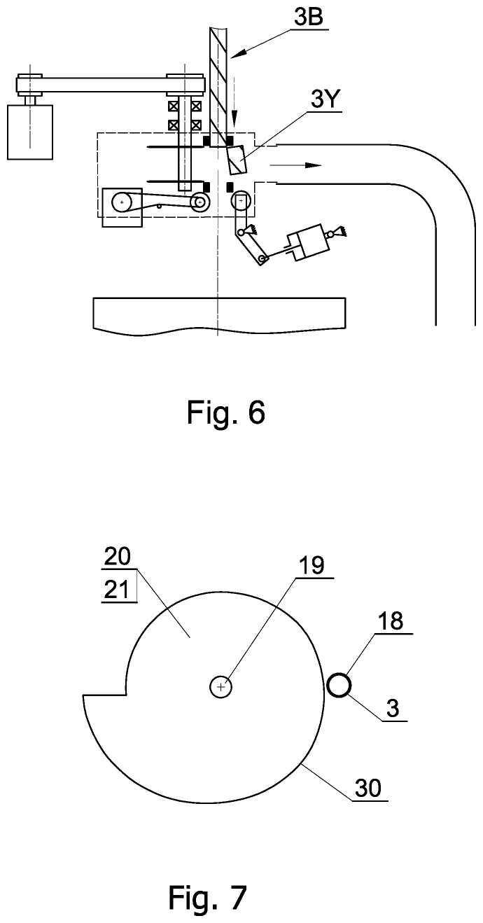

FIG. 6 shows the cutting unit and the conveyor unit during removal of an upper scrap section,

FIG. 7 shows a circular knife having a spiral cutting edge and its position in relation to the continuous tube,

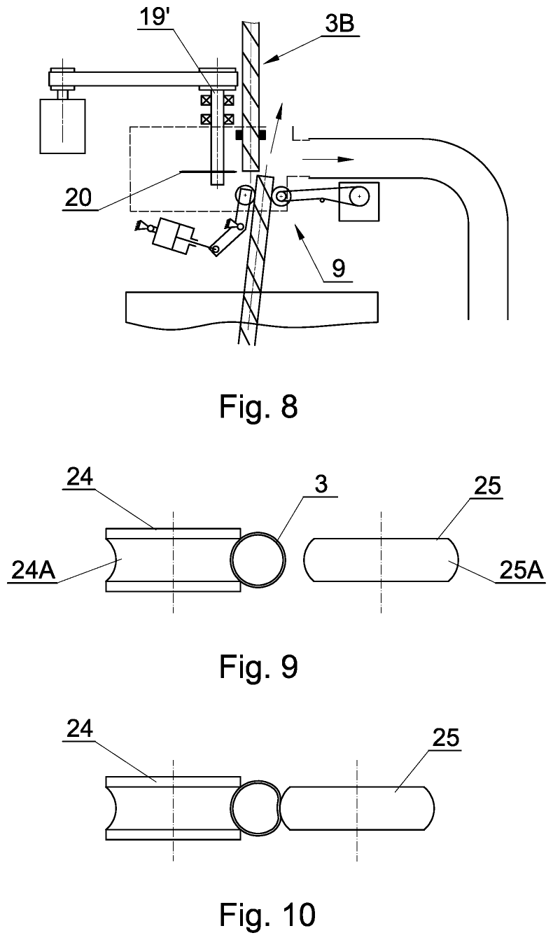

FIG. 8 shows the cutting unit in the second embodiment and the conveyor unit during removal of a lower scrap section,

FIG. 9 shows rollers of the conveyor unit during spiral tube manufacturing, and

FIG. 10 shows the rollers of the conveyor unit during removal of a scrap section.

An apparatus 1 for manufacturing of spiral tubes 2 cut off of a continuous spiral tube 3 comprises feeding units 4 for feeding material strands, it comprises further a glue unit 5, a forming unit 6, a cutting head 7, a cutting unit 8, and a conveyor unit 9.

The feeding unit 4 for feeding a material strand is adapted to unwind the material strand from a bobbin and feed such strand to the forming unit 6. The embodiment presented in FIG. 1 shows the apparatus 1 provided with two feeding units 4, 4′ for feeding two material strands 10, 10′. For simplicity, the figure does not show the bobbins from which the material strands 10, 10′ are unwound. The material strand 10, 10′ is guided through multiple rollers, in the figure the last roller is marked as 11, 12 for each of the material strands 10, from these rollers the material strand 10, 10′ runs directly to a forming rod 13 in the forming unit 6. The material strand 10′ passes the glue unit 5 which feeds the glue continuously onto the surface of the strand.

The forming unit 6 is adapted to receive the material strands 10, 10′ and to wind such strands in such a way that a spiral tube layer is continuously formed of the material strand, in the following description the formed tube 3 will be referred to as a continuous tube or a continuous spiral tube. The forming unit 6 comprises the forming rod 13, a forming strip 14 and a drive unit 15 of the forming strip 14. Each of the rollers 16, 17 may be a drive roller, in the embodiment shown in FIG. 1 the drive is transmitted from the motor M through the roller 16 to the forming strip 14.

The cutting head 7 is situated below the forming unit 6 and is adapted to cut off individual spiral tubes 2 of the continuous spiral tube 3. The cutting head 7 is provided with a rotating body in which movable circular knives are mounted, and the channel for the continuous spiral tube 3 is situated coaxially with the forming rod 13. The circular knives rotate around their axes and when cutting the tube they move in a direction parallel to the axis of rotation of the body at a speed equal to the speed of continuous tube forming, which makes it possible to cut off individual spiral tubes of the moving continuous tube 3. The operation of such cutting head is described in more detail in the international publication W02020099361A1. The individual spiral tubes 2 may be received from the cutting head 7 in any way.

The cutting unit 8 is situated between the forming rod 13 and the cutting head 7 and is adapted to cut through the continuous tube 3. The cutting unit 8 may be adapted to cut through the continuous tube 3 and at the same time to cut out a fragment of the continuous tube 3. The cutting unit 8 is provided with a through channel 18 for the continuous tube 3, and the continuous spiral tube 3 moves axially through the through channel 18. The cutting unit 8 may be provided with a knife shaft, whereas at least one circular knife or a knife having a spiral cutting edge may be attached to the knife shaft, and the circular knife having a circular cutting edge is attached eccentrically to the rotation axis of the knife shaft. In the embodiment shown in FIG. 2, the knife shaft 19 is rotatably mounted in such a way that its axis of rotation k is parallel to the axis m of the through channel 18, whereas the knife shaft 19 is provided with two knives 20, 21 with a spiral cutting edge 30, whereas FIG. 7 shows the position of the knife 20, 21 relative to the through channel 18 and the continuous tube 3 before making the rotation to cut the continuous tube 3. The knife shaft 19 is driven by a motor 22 and a toothed belt gear 23. The motor 22 is adapted to stroke cycle operation so that the knife shaft 19 makes one rotation together with the knives 20, 21 and stops. FIG. 3 shows a situation before making the rotation, i.e. before cutting the continuous tube 3, and FIG. 4 shows a situation after the rotation made by the knife shaft 19, whereas the continuous spiral tube 3 or the scrap section 3A of the continuous tube 3 does not move during cutting or moves at low speed. The upper scrap section 3B and the lower scrap section 3C resulting from cutting of the scrap section 3A may be cut into fragments and removed, which will be discussed in the following description.

The cutting unit 8 is adapted to cutting of the continuous tube 3 and cutting of the upper scrap section 3B moved downwards by means of the upper circular knife 20 and to cutting of the lower scrap section 3C moved upwards by means of the lower circular knife 21. In the case of the cutting unit 8 provided with one circular knife (FIG. 8) the same knife 20 is used for cutting the upper scrap section 3B and the lower scrap section 3C.

Underneath the cutting unit 8, there is situated a conveyor unit 9 adapted to remove the lower scrap section 3C of the continuous tube, whereas the lower scrap section 3C may be cut during the transport of such section. The conveyor unit 9 is provided with conveyor rollers 24, 25 (FIG. 2). The driving conveyor roller 24 has a cylindrical circumferential surface or a concave circumferential surface 24A (FIG. 9), and the adjustable conveyor roller 25, situated on the opposite side of the continuous tube 3, has a convex circumferential surface 25A. The adjustable conveyor roller 25 is mounted at an end 27 of a lever 26 which is rotatably mounted at the point 28. An articulated actuator 31 is mounted to the other end 29 of the lever 26. The operation of the actuator 31 causes a change in the position of the adjustable conveyor roller 25 so that the continuous spiral tube 3 is squeezed between the driving conveyor roller 24 and the adjustable conveyor roller 25, as shown in FIG. 3 and FIG. 10. The driving conveyor roller 24 is driven by a motor 32 by means of belt gear 33. The drive of the conveyor roller 24 works in stroke cycles. During the removal of the scrap section 3C, the conveyor roller 24 rotates in one direction so that such section moves upwards, whereas a rotary actuator may be used to drive the roller 24.

During the operation of the apparatus 1 for manufacturing of spiral tubes, the material strands 10, 10′ are fed from the feeding unit 4, 4′ to the forming unit 6, and the material strands 10, 10′ are wound around the forming rod 13. The first material strand 10 is wound as first, the second material strand 10′ is wound as second and onto one side of the latter a glue layer is applied by means of the glue unit 5. The fed material strands 10, 10′ are pressed against the forming rod 13 by means of the forming strip 14. The forming loop 14A of the forming strip 14 causes that during the movement of such strip the material strands 10, 10′ are pressed simultaneously against the forming rod 13 and against each other, and that the continuous spiral tube 3 being formed is turned and linearly moved. The moving continuous spiral tube 3 is cut by means of the cutting head 7 into individual tubes 2.

After a short stop, the apparatus 1 may be restarted. After a stoppage or after the end of operation of the apparatus 1, in the apparatus 1 for manufacturing of spiral tubes 2 there remains a certain scrap section of the continuous tube 3A of which individual tubes can no longer be manufactured or only tubes of reduced quality may be manufactured. If defects in the material strand 10, 10′ being fed are detected, the apparatus 1 is stopped, and the at least partially properly formed continuous tube 3A remaining in the machine is treated as the scrap section 3A and should be removed. In the process of removal, the scrap section 3A of the continuous tube is pressed by the adjustable conveyor roller 25 against the driving conveyor roller 24, then the cutting unit 8 and the conveyor unit 9 are alternately activated. The first activation of the cutting unit 8 results in a rotation of the circular knives 20, 21, which results in cutting the scrap section 3A into the upper scrap section 3B and the lower scrap section 3C, and cutting out the fragment 3X which is removed by the suction nozzle 34 (FIG. 4). Besides, the fragment 3X may be cut out at the time of cutting the continuous spiral tube 3. The rotation of the conveyor roller 24 of the conveyor unit 9 causes that the lower scrap section 3C is moved upwards, and the rotation of the circular knife 21 causes that a successive fragment 3Z is cut off from the lower scrap section 3C, then the lower scrap section 3C is alternately moved and cut, and the successive fragments 3Z are removed by the suction nozzle 34 (FIG. 5). The lower scrap section 3C of the continuous tube is moved and the successive fragments of such section are cut off until the scrap section 3C is completely removed. The last fragment of the scrap section 3C, which may be smaller in length than the previously cut off fragments 3Z, may also be moved upwards and removed by the suction nozzle 30.

In the case of the knife shaft 19″ with one circular knife 20, the scrap section 3A is only cut. The lower scrap section 3C may be deflected from the vertical direction and removed by means of the conveyor unit 9 (FIG. 8).

After stopping the machine 1, on the forming rod 13 and beneath the forming rod 13 there is a certain section of the formed continuous spiral tube 3. After a long-time stoppage of the machine, both the material strand with any dried glue and the scrap section 3A of the tube may be removed before the production is restarted. After cutting the continuous tube 3 and removing the lower scrap section 3C, the upper scrap section 3B must be removed. The apparatus 1 is started at low speed and the cutting unit 8 is started. The upper scrap section 3B moves downwards and is cut into fragments 3Y by the cutting unit 8 (FIG. 6). A tube is formed of material strands with dried glue, and such tube moves downwards and is also cut into the fragments 3Y. The movement of the scrap section 3B may take place in steps and alternately with the actuation of the cutting unit 8. After removing the upper scrap section 3B of the tube and the scrap material strands connected to it, the apparatus 1 is ready for manufacturing of tubes 2. Also in the case of the start of production, when material strands on which no glue has been applied yet are inserted in the apparatus, some fragment of the continuous tube 3 formed of such strands must be removed as in the case of removal of the upper scrap section 3B.

The apparatus for manufacturing of spiral tubes according to the invention may work horizontally, i.e. when the forming rod is directed horizontally.

1. An apparatus (1) for manufacturing of spiral tubes (2) having at least two layers, comprising at least two feeding units (4, 4′) for feeding a material strand (10, 10′),
at least one glue unit (5) for feeding glue onto the material strand (10, 10′),
a forming unit (6) comprising a forming rod (13) and a forming strip (14) winding around a formed fragment of a continuous spiral tube (3),
and a cutting head (7) for cutting off an individual tube (2) from the continuous spiral tube (3),
characterised in that
between the forming rod (13) and the cutting head (7) there is situated a cutting unit (8) for cutting the formed or partially formed continuous spiral tube (3) or a scrap section (3A) of the tube.

2. The apparatus as in claim 1, characterised by being provided with a conveyor unit (9) for removing a cut-off section (3C) of the continuous spiral tube (3).

3. The apparatus as in claim 2, characterised in that the conveyor unit (9) comprises at least two conveyor rollers (24, 25).

4. The apparatus as in claim 3, characterised in that the conveyor unit (9) comprises at least one conveyor roller (24) having a concave circumferential surface (24A).

5. The apparatus as in claim 3, characterised in that the conveyor unit (9) comprises at least one conveyor roller (25) having a convex circumferential surface (25A).

6. The apparatus as in claim 2 characterised in that one of the conveyor rollers (24) is driven by a roller drive unit.

7. The apparatus as in claim 2 characterised in that at least one conveyor roller (25) is adjustable.

8. The apparatus as in claim 1 characterised in that the cutting unit (8) comprises at least one circular knife (20, 21) mounted eccentrically or having a spiral cutting edge.

9. The apparatus as claim 1 characterised in that in the area of the cutting unit (8) a suction nozzle (34) is situated.

10. A method for manufacturing of spiral tubes (2) having at least two layers, in an apparatus (1) which comprises
feeding a material strand (10, 10′) by at least two feeding units (4, 4′),
feeding glue onto the material strand (10, 10′) by means of at least one glue unit (5), forming a continuous spiral tube (3) by means of a forming unit (6) comprising a forming rod (13) and a forming strip (14) winding around the formed part of the continuous spiral tube (3), and
cutting off individual tubes (2) of the continuous spiral tube (3) formed on the forming rod (13) by means of a cutting head (7),
characterised by
stopping the apparatus (1) for manufacturing of the tubes (2),
cutting the at least partially formed continuous spiral tube (3) or a scrap section (3A) of the continuous tube (3A) between the forming rod (13) and the cutting head (7) by means of a cutting unit (8).

11. The method as in claim 10 characterised by comprising an additional step of removing the cut-off scrap section (3C) of the continuous tube by means of a conveyor unit (9) in a direction opposite to the continuous spiral tube (3) manufacturing direction.

12. The method as in claim 11 characterised by cutting off a fragment (3Z) of the scrap section (3C) and removing the cut-off fragment (3Z).

13. The method as in claim 12 characterised by sucking off the cut-off fragment (3Z).

14. The method as in claim 10 characterised by cutting out a fragment (3X) of the continuous tube simultaneously with the cutting through the continuous spiral tube (3).
